(19) United States
(12) Patent Application Publication
(10) Pub. No.: US 2024/0360534 A1
(43) Pub. Date: Oct. 31, 2024

(54) METHOD FOR PRODUCING HIGH-STRENGTH TINPLATE AND TINPLATE PRODUCED THEREWITH

(71) Applicant: TATA STEEL IJMUIDEN B.V., Velsen-Noord (NL)

(72) Inventor: John Antony GAMBLE, Schoorl (NL)

(73) Assignee: TATA STEEL IJMUIDEN B.V., Velsen-Noord (NL)

(21) Appl. No.: 18/688,076

(22) PCT Filed: Oct. 13, 2022
(86) PCT No.: PCT/EP2022/078565

§ 371 Date: Feb. 29, 2024

(30) Foreign Application Priority Data
Oct. 14, 2021 (EP) 21202573.8
Oct. 26, 2021 (EP) 21204747.6

(51) Int. Cl. C21D 9/46; B32B 1/08; B32B 15/08; B32B 15/18; B32B 37/15; B32B 37/20; B32B 38/00; B65D 8/00; B65D 25/14; B65D 25/34; C21D 6/00; C21D 8/02; C22C 38/00; C22C 38/02; C22C 38/04; C22C 38/06; C22C 38/42; C25D 5/36; C25D 7/06

(52) U.S. Cl. CPC C21D 9/46; B32B 1/08; B32B 15/08; B32B 15/18; B32B 37/153; B32B 37/206; B32B 38/0004; B65D 7/04; B65D 25/14; B65D 25/34; C21D 6/004; C21D 6/005; C21D 6/008; C21D 8/0205; C21D 8/0226; C21D 8/0236; C21D 8/0263; C21D 8/0273; C22C 38/001; C22C 38/002; C22C 38/02; C22C 38/04; C22C 38/06; C22C 38/42; C25D 5/36; C25D 7/0614; B32B 2250/03; B32B 2250/40; B32B 2255/06; B32B 2255/205; B32B 2307/54; B32B 2311/16; B32B 2311/30; B32B 2439/66

(57) ABSTRACT

A method for producing high strength three piece steel can body and cans produced therewith.

### FIELD OF THE INVENTION

This invention relates to a method for producing high-strength tinplate and tinplate produced therewith.

### BACKGROUND OF THE INVENTION

Most of the cans produced today are one of two types: 3-piece cans consisting of three components of a bottom lid, a body, usually more or less cylindrical, and a top lid, and 2-piece cans consisting of two components of a body integrated with a bottom lid and a top lid.

A technique called double seaming is usually used to attach the can body to the can lids (top and bottom) and the contents of the can are subsequently protected from external contamination. 3-piece cans can bodies are made of a rectangular sheet rolled into a (cylindrical) body and the edges are joined together by soldering or welding. Welded cans dominate the market while soldered cans have almost all disappeared from the market.

Tinplate is light gauge, cold-rolled low-carbon steel sheet or strip, coated on both faces with commercially pure tin to protect the steel sheet from corrosion, which is used mainly in the packaging industry. The tin layer is usually deposited electrolytically, usually in a continuous production line.

The steel substrate for tinplate is produced as a single reduced (SR) and as double reduced (DR) strip (see FIG. 1). A single reduced strip is cold-rolled directly to the final gauge, then annealed and tinned. A double reduced product is given a first cold-rolling reduction to reach an intermediate gauge, then annealed and then given a second cold-rolling reduction to the final gauge. The resulting DR product is normally stiffer, harder and stronger than an SR product which may allow utilising a lighter gauge steel for specific applications.

Tinplate combines in one material the strength and formability of steel and the corrosion resistance, solderability and good appearance of tin. Within this broad description, there exists today an extremely wide range of products, tailor-made to meet end-use requirements. Production of the steel base and its subsequent coating with tin are independent of each other, so that any set of properties in the steel, can in theory be combined with any tin coating. The composition of the steel used for tinplate is closely controlled and according to the grade chosen and its manner of processing, various types with different formabilities (“tempers”) can be produced. Tinplate is sold in a range of steel thicknesses, from around 0.10 mm to 0.49 mm. The steel can be coated with differing thicknesses of tin. Even different thicknesses on the two faces (differential coatings) may be produced to cater for varying conditions at the internal and external surfaces of a container. A variety of surface finishes are also produced for diverse applications.

Tin is deposited as a whitish coating having a slight metallic lustre. When required this is flow-melted by induction or resistance heating (or a combination) to produce a bright mirror-like finish. This flow-melting process enhances the corrosion resistance of the product by formation of an inert tin-iron alloy layer.

When producing the blanks for the three-piece can bodies from a strip of tinplate there are two basic options: so-called C-grain and H-grain blanks.

C-grain blanks are cut from the strip in such a way that the edge of the blank which is to be welded is parallel to the width of the coil. H-grain blanks are cut from the strip in such a way that the edge of the blank which is to be welded is perpendicular to the width of the coil (see FIG. 2). So C-grain can bodies are three-piece welded can bodies for which the weld (or welding direction) is perpendicular to the rolling direction of the body sheet. The C stands for circumferential—the rolling direction lies in the circumference of the can body (see FIG. 2). H-grain can bodies are three-piece welded can bodies for which the weld (or welding direction) is parallel to the rolling direction of the body sheet (see FIG. 2). The H stands for height—the rolling direction lies in the height of the can body.

In the years of ingot cast steel, dirt particles were rolled-in in the material. These lines of dirt particles were aligned along the rolling direction and so can bodies made with the rolling direction parallel to the weld (H-grain cans) suffered more risk of split flanges due to the dirt particles inside the material. For this historical reason most of the three piece cans were (and still are) produced as C-grain cans. Nowadays there is another reason for keeping the C-grain format. Most of the three-piece (food) cans are made from DR material qualities because the secondary reduction of the recrystallisation annealed cold rolled steel strip provides the steel with additional strength. The difference in mechanical properties with respect to the rolling direction (anisotropy), which is intrinsic to DR materials, favours the C-grain cans. A smaller risk of flange cracks and a larger welding range for C-grain cans are the main reasons to stay with the C-grain can bodies. The welding range (also referred to as welding latitude) is expressed in the electrical current (in Amperes) required to produce weld nuggets in the weld that are neither too cold or too hot. Too cold welds reduces weld strength, and too hot increases risk of molten metal splashing.

### OBJECTIVES OF THE INVENTION

It is an objective of this invention to provide a method for producing high strength tinplate with a tensile strength of between 435 and 700 MPa with an improved H-grain weldability, i.e. a maximised welding range, for three-piece can bodies.

It is also an objective of this invention to provide a method for producing welded three piece can bodies with a tensile strength of between 435 and 700 MPa.

It is also an objective of this invention to provide a method for producing welded three piece can bodies with a tensile strength of between 435 and 700 MPa with a reduced or no secondary cold rolling reduction.

### DESCRIPTION OF THE INVENTION

The objective of the invention is reached by a method for producing high-strength tinplate with a lower yield strength (R_{eL}) of between 435 MPa and 700 MPa with improved H-grain weldability for three-piece can bodies comprising the subsequent steps of: Producing a hot-rolled strip by hot-rolling a steel slab produced by the BOF-steelmaking process comprising (in wt. %):
C: 0.045-0.095;
Mn: 0.250-0.475;
Si: 0-0.030
Al_sol: 0.005-0.025;
N: 0.0070-0.0140;
S: 0-0.020;
P: 0-0.020;

Optionally one or more of the following:
Cr: 0-0.100;
Cu: 0-0.100;
Ni: 0-0.100;
Ti: 0-0.010;
Nb: 0-0.010;
V: 0-0.010;
remainder iron and inevitable impurities resulting from the steelmaking process, wherein the hot-rolled strip preferably has a crown value C40 of at most 0.045 mm;
followed by a first cold-rolling of the hot-rolled strip to an intermediate thickness, wherein the first cold-rolling reduction is between 85% and 91%, and wherein the cold-rolled strip is subsequently subjected to recrystallisation annealing by continuous annealing or batch annealing to produce a fully recrystallised annealed strip;
followed by a second cold rolling of the fully recrystallised annealed strip to a final thickness wherein the second cold-rolling reduction is between 2% and 17%;
followed by electro-tinning the annealed strip on one or both sides to produce tinplate.

The inventors found that in order for the three piece can to attain the desired strength that a tailored chemical composition of the steel strip is needed. The process starts with producing a thick or a thin steel slab for which a steel melt is produced in the BOF steelmaking process based on pig iron from a blast furnace or a direct reduction process or in an EAF-steelmaking process. The EAF-process generally results in higher amounts of inevitable impurities/residual elements in the steel produced in this process as a result of the process being predominantly based on melting scrap and/or directly reduced iron and due to the more limited options to refine the steels in the EAF-process compared to the BOF process. The BOF-steelmaking process is therefore preferred as a steelmaking process to produce the steels according to the invention, but not limited thereto.

It is off course possible to refine the EAF-melt in a BOF steelmaking process. For the sake of this invention the combination of EAF and BOF is considered also to be a BOF steelmaking process.

After the steelmaking process the slab is processed into a hot-rolled rolled strip in a conventional hot-strip mill or in a thin-slab casting and direct-rolling mill.

It is noted that the chemical composition of the steel slab can be varied in the claimed ranges independently, as long as the individual elements stay within their respective claimed range.

Sulphur and phosphorus are residual elements and are not considered to be a beneficial element. They are considered inevitable impurities hence their presence is preferably limited. Preferably the sulphur and the phosphorus content is each below 0.015%, and preferably below 0.010%. Aluminium is used as a deoxidant to remove oxygen from the steel melt. Some aluminium is still present in the steel as alumina, and the remainder is referred to as Al_sol and this may be present as aluminium in solid solution or e.g. precipitated as AlN.

Preferably the maximum amount of the optional elements Cr, Ni and Cu is 0.075 respectively, and more preferably 0.060% respectively. Preferably the amount of Sn, Mo and B as inevitable impurities is 0-0.030, 0-0.020 and 0-0.005 respectively;

In a preferred embodiment the steel slab produced by the BOF-steelmaking process comprises (in wt. %):
C: 0.045-0.095;
Mn: 0.250-0.475;
Si: 0-0.030
Al_sol: 0.005-0.025;
N: 0.0070-0.0140;
S: 0-0.020;
P: 0-0.020;
Cr: 0-0.030;
Cu: 0-0.040;
Ni: 0-0.060;
Ti: 0-0.004;
Nb: 0-0.004;
V: 0-0.004;
Ni+Cu+Cr+Mo+Sn+Nb+Ti+V: 0-0.100;
remainder iron and inevitable impurities resulting from the steelmaking process.

Copper, Nickel and Chromium are also inevitable impurities as it is difficult to remove them from the melt, and in small quantities their presence does not adversely affect the performance of the steel. Also tin and molybdenum are inevitable impurities and their levels have to be carefully controlled as their presence may adversely affect the performance of the steel. It is preferable to keep the sum of the most important residual elements (Ni+Cu+Cr+Mo+Sn+Nb+Ti+V) below 0.100%.

In order to be able to produce the required H-grain weldability in the final tinplate it is very important that the hot-rolled strip is as flat as possible. Thickness variations over the width lead to variations in thickness of the materials to be welded together, and it is in the interest of the welding efficiency and weld quality of the can bodies. If the welding window is large then the weld quality and welding efficiency is maximised over a large range of thicknesses of the edges to be welded together which is of particular importance for producing H-grain bodies because of the thickness variations over the width of the strip, but is also valuable for producing C-grain can bodies.

When hot rolling a strip, a crown is formed over the width, which is a difference in thickness with the maximum thickness in the centre and minimum thickness near the edges. It is a well-known fact that the crown that is produced in the hot-rolling process cannot be altered in the subsequent cold rolling without flatness defects in the resulting cold-rolled strip. The relative crown and wedge are measured at a certain distance from the edge due to the edge drop. In case of C40 and W40 this distance is 40 mm from the edge and the crown and wedge are calculated as follows:

$${C}_{40} = \frac{{t}_{CL} - \frac{{t}_{40 , LeftEdge} + {t}_{40 , RightEdge}}{2}}{{t}_{CL}} \times 100 [ \% ] \\ {W}_{40} = \frac{{t}_{40 , LeftEdge} + {t}_{40 , RightEdge}}{{t}_{CL}} \times 100 [ \% ]$$

The inventors found that a C40 crown value of the hot-rolled strip of at most 0.045 mm is preferred. More preferably C40 is below 0.040 mm, even more preferably below 0.035 and most preferably below 0.030 mm. This low level of crown of the hot-rolled strip allows the cold-rolling process to produce a strip with a very small thickness differential over the width, which is a huge benefit for the H-grain welding process for the production of three-piece can bodies from the cold-rolled strip, because then the difference in thickness of the edges to be welded together is correspondingly small. Coupled with the chemistry of the steel this provides the welding process with a larger welding window in which to produce a perfect weld, without having to change the welding parameters. Irrespective of whether the blanks are cut from the edge of the strip or the centre if the strip, the larger welding window will allow production of a perfect weld. If the crown is higher than 0.045 mm, or if the chemistry is not within the ranges as described herein above, the welding window or the flanging capacity may become insufficient to deal with the differences in thickness, resulting in the production of weld nuggets in the weld that are too cold or too hot.

Achieving a low hot-strip crown C40 value causes challenges in the hot-strip mill because a high crown helps the hot strip mill. It should be noted that the desired crown values of the hot-rolled strip could also be attained by cutting the edges off until the crown reaches the desired minimum value of 0.045 mm. This cut hot-rolled strip can subsequently be processed into cold-rolled strip according to the invention. Economically this is unattractive because it results in a loss of material that underwent already a degree of processing. It should also be noted that a cold-rolled strip is already produced with a certain amount of over-width. By targeting a degree of over-width the process ensures that at least the desired amount of blanks can be cut from the width of the final cold-rolled strip. It is clear that it is important that the amount of cutting loss is minimised to minimise material and financial loss. By ensuring a low hot strip mill crown this can be achieved.

The hot-rolled strip is cold-rolled with a first cold-rolling reduction of between 85% and 91% in the first reduction, subsequently recrystallisation annealed, and then subjected to a second cold-rolling reduction of between 2 and 17%, depending on the desired final tensile strength level and thickness. Finally the DR-reduced strip is provided with a tin layer on one or both sides using a known continuous electro-tinning line. In a preferred embodiment the annealing is performed in a continuous annealing line (CA-line). Higher heating rates and cooling rates can be achieved in a CA-line in comparison to batch annealing which allows a much faster process cycle and also produces a more homogeneous product over the length and width of the strip which is beneficial for the 3-piece can production. Also, with the higher heating and in particular the higher cooling rates smaller grainsizes can be produced which may result in a higher strength of the material.

One important advantage of H-grain bodies is of a commercial nature. The height of a can body is determined by the blank size. It is much easier to change the can height for a fixed diameter of an H-grain can body because the blanks are cut from the strip in the rolling direction, and the width of the strip is tailored to the number of blanks that are taken from the width of the strip. The number of specs is reduced which leads to cost reduction for the canmaker.

There is an additional advantage to promote H-grain welding in some cases. In the situation of welding pre coated materials like side striped polymer coated steel substrates, such as Tata Steels proprietary Protact® material, only H-grain cans can practically be produced en masse.

In an embodiment the minimum carbon content is 0.050%, and preferably the maximum carbon content is 0.090%. Carbon is the principal hardening element in steel and as carbon content increases the hardness increases. However ductility and weldability decrease with increasing carbon.

In an embodiment the manganese content is at least 0.300%, preferably at least 0.325%. A suitable maximum manganese content is 0.450%, and preferably at most 0.425%.

In an embodiment the steel slab according to the invention comprises at most 0.020% Si, preferably at most 0.015% Si and even more preferably at most 0.010% Si. Silicon is a residual element and is not considered to be a beneficial element for tinplate and hence its presence is preferably limited. Silicon is known to adversely affect the corrosion resistance of tinplate in some cases. Ti and Nb are residual elements and affect the properties of the steel when present already in minute amounts. The Nb and the Ti contents are therefore preferably further limited to at most 0.002 and 0.002% respectfully.

The amount of tin, and thus the thickness of the tin layer, that is deposited onto the surface of the double reduced substrate affects the weldability, and therefore the amount of tin on the tinplate is preferably at most 5.0 g/m2, more preferably at most 4.5 g/m2 and even more preferably at most 4.0 g/m2.

In order to retain sufficient corrosion resistance after welding the amount of tin on the tinplate is preferably at least 1.5 g/m2, more preferably at least 2.0 g/m2 and even more preferably at least 2.5 g/m2 or even at least 2.8 g/m2.

The method can be used to produce blanks for 3-piece cans in C-grain or in H-grain orientation. However, the method according to the invention is extremely well suited to include a lamination step wherein a thermoplastic polymer laminate layer is applied to one or both sides of the tinplate to form a laminate. The laminate thus consists of a steel substrate provides on one or both sides with a tin layer thereby producing tinplate and wherein this tinplate is further provided with a thermoplastic polymer laminate layer on one or both sides. The thermoplastic polymer laminate layer may be applied to one or both sides of the tinplate by means of direct extrusion and in-line lamination, or by film lamination using an adhesion layer to bond the thermoplastic polymer laminate layer or layers to the tinplate, or by film lamination using heat-bonding to bond the thermoplastic polymer laminate layer or layers to the tinplate. The polymer laminate layer may be identical on both sides of the tinplate.

In order to produce three piece can bodies the tinplate or the laminate is further processed by cutting rectangular body blanks for three-piece can bodies from the tinplate or laminate. Such a rectangular blank has two sides, w, where the weld is to be made to form the can body, and c, which is to become the circumference of the can body after welding. Depending on the orientation of this blank with respect to the rolling direction of the cold rolled strip two types of can bodies can be produced:
C-grain: w⊥RD and c//RD
H-grain: w//RD and c⊥RD

When producing a blank from a laminate, then the weld area needs to be bare metal, because otherwise the can body cannot be welded. For a C-grain can body this is complicated because each blank needs to be treated individually by means of e.g. mechanical (e.g. scouring), chemical (e.g. dissolution) or optical (e.g. laser) means. This is not preferable from a productivity point of view. It is advantageous to use H-grain blanks for this purpose because the laminate can be formed by leaving narrow strips of tinplate uncovered and laminating only the parts outside the weld area, or by removing the laminate layer locally before blanking in the direction//RD.

In an embodiment the tinplate is provided with a thermoplastic polymer laminate layer to form a laminate. This has the advantage that the can body produced therewith is additionally protected against corrosion, and the laminate layer may also provide a good basis for decorative printing. However, in order to enable the welding of the can bodies the edges of the blanks to be welded need to be bare (i.e. not covered by a thermoplastic polymer laminate layer, but bare tinplate), and these welded areas need to be protected against corrosion after welding (see FIG. 4). The thermoplastic polymer laminate layer may be applied to one or both sides of the tinplate by means of direct extrusion and in-line lamination, or by film lamination using an adhesion layer to bond the thermoplastic polymer laminate layer or layers to the tinplate, or by film lamination using heat-bonding to bond the thermoplastic polymer laminate layer or layers to the tinplate (see FIGS. 5 and 6).

Preferably, when using a laminate, a plurality of thermoplastic polymer laminate layers are applied to one or both sides of the tinplate in such a way that narrow longitudinal strips of tinplate remain unlaminated. The laminate is slit into narrow laminate strips with a width c having unlaminated edges on either side in the direction parallel to the rolling direction by slitting the laminate along the unlaminated narrow longitudinal strips.

The plurality of thermoplastic polymer laminate layers have a width that is marginally smaller than the blank to be cut from the strip. The blanks are cut in the unlaminated narrow longitudinal strips, leaving just enough bare tinplate for the welding to close the can body to take place. This is a preferable embodiment because it relieves the can body producer of the removal of the laminate from the edges to enable the weld.

In a preferable embodiment three-piece can bodies are producible from the tinplate or laminate by cutting rectangular body blanks therefrom, wherein the side c of the rectangular body blank which will form the circumference of the can body is perpendicular to the rolling direction of the cold-rolled strip, and wherein the side w where the weld to close the can body is to be made is parallel to the rolling direction of the tinplate or laminate (H-grain).

In an embodiment three-piece can bodies are producible from the tinplate or laminate by cutting rectangular body blanks therefrom, wherein the side c of the rectangular body blank which will form the circumference of the can body is parallel to the rolling direction of the cold-rolled strip, and wherein the side w where the weld to close the can body is to be made is perpendicular to the rolling direction of the tinplate or laminate (C-grain).

According to a second aspect the invention is also embodied in tinplate or a laminate produced by means of the method according to the invention, and to body blanks or three piece can bodies produced therefrom.

In an embodiment the high-strength tinplate with a lower yield strength (ReL) of between 435 MPa and 700 MPa with improved H-grain weldability for three-piece can bodies comprising (in wt. %):
C: 0.045-0.095;
Mn: 0.250-0.475;
Si: 0-0.030
Al_sol: 0.005-0.025;
N: 0.0070-0.0140;
S: 0-0.020;
P: 0-0.020;

Optionally one or more of the following:
Cr: 0-0.100;
Cu: 0-0.100;
Ni: 0-0.100;
Ti: 0-0.010;
Nb: 0-0.010;
V: 0-0.010;
remainder iron and inevitable impurities

In a preferred embodiment the high-strength tinplate comprises:
Cr: 0-0.030;
Cu: 0-0.040;
Ni: 0-0.060;
Ti: 0-0.004;
Nb: 0-0.004;
V: 0-0.004;
Ni+Cu+Cr+Mo+Sn+Nb+Ti+V: 0-0.100;

In an embodiment the high strength tinplate according has a H-grain welding range of at least 350 A, preferably of at least 400 A.

In an embodiment the high strength tinplate or laminate has a H-grain flanging capacity of at least 8.0%.

Where reference has been made to can bodies herein above it should be noted that these can bodies can have a circular cross-section, but they may also have a different cross section, such as oval, square, rectangular or the like. The invention as described herein is equally applicable to these less conventional can body shapes.

According to a third aspect the invention is also embodied in body blanks for three-piece cans produced from the tinplate or laminate according to the invention and to three piece can bodies produced from rectangular body blanks produced according to wherein the body blank is shaped into a cylinder or any other suitable shape and welded to form open ended closed bodies wherein the weld seam that closes the can body is parallel to the rolling direction of the laminated tinplate.

### EXAMPLES

To test the performance of the steel according to the invention in a three piece welded can body, the welding range for C and H-grain bodies was determined together with the flanging capacity of the bodies.

TABLE 1
Composition (in 1/1000 wt. % unless otherwise indicated).

| | | | | | | | N | | | | | | |
|---|---|---|---|---|---|---|---|---|---|---|---|---|---|
| | | C | Mn | P | S | Si | (ppm) | Al_sol | Nb | Cr | Cu | Ni | Σ |
| Nb | Comp | 45 | 246 | 13 | 11 | 10 | 20 | 34 | 9 | 34 | 23 | 19 | 83 |
| LC | Comp | 72 | 349 | 14 | 11 | 2 | 22 | 40 | — | 33 | 22 | 30 | 89 |
| N | Inv | 75 | 395 | 13 | 8 | 1 | 119 | 17 | — | 23 | 13 | 21 | 60 |

TABLE 2
Production details.

| | t | t | | t | | | | | | | |
|---|---|---|---|---|---|---|---|---|---|---|---|
| | HSM | CSM | DR | final | Sn | FRT | CT | R_{eL} | Aₜ | A_{g} | |
| | (mm) | (mm) | (%) | (mm) | (g/m²) | (° C.) | (° C.) | (MPa) | (%) | (%) | C40 |
| Nb | 1.8 | 0.19 | 14 | 0.17 | 2.8/2.8 | 895 | 600 | 510 | 5.0 | 3.5 | 46 |
| LC | 2.2 | 0.24 | 36 | 0.18 | 2.0/2.0 | 880 | 630 | 542* | 10.7 | 1.6 | 39 |
| N | 1.8 | 0.18 | 12 | 0.16 | 2.8/2.8 | 885 | 590 | 609 | 4.7 | 1.8 | 33 |

Tensile tests were performed according to EN10002-1-2001 E.
t=thickness; HSM=Hot strip mill; CSM=Cold strip mill; DR=percentage of 2^{nd} cold reduction; t final=thickness after 2^{nd} reduction; Sn=tin weight per side in g/m2; FRT=HSM finish rolling temperature; CT=Coiling temperature; R_{eL}=lower yield strength; Ag=uniform strain; At=total strain; C40=hot strip crown.
LC was batch annealed. This value is R_{p0.2} (in MPa).

TABLE 3
Welder settings.

| Welding speed | 84.4 | m/min |
|---|---|---|
| Production | 739 | cpm |
| Frequency | 977 | Hz |
| Wave form | sine | |
| Nugget pitch | 0.72 | mm |
| Electrode force | 50 | daN |

The welding trials were executed using a Soudronic AFB1000 bodywelder. The overlap at the weld is 0.5 mm. The upper welding limit is determined by the occurrence of spattering during welding (=“hot weld”), and the lower boundary when during testing of the body the bodies fail at the weld (=“cold weld”).

The results of the welding trials are presented in table 4

TABLE 4
Results of the welding trials

| | C - grain | | | H - grain | | | |
|---|---|---|---|---|---|---|---|
| | Lower | Upper | | Lower | Upper | | |
| | limit | limit | Range | limit | limit | Range | |
| | [A] | [A] | [A] | [A] | [A] | [A] | Welding range |
| Nb | 4800 | 5000 | 200 | 4800 | 4950 | 150 | Too low |
| LC | 4750 | 5300 | 550 | 4900 | 5000 | 100 | OK for C-grain |
| N | 4700 | 5500 | 700 | 4850 | 5300 | 450 | OK for C & H-grain |

The welding ranges of the material according to the invention are high and even larger than the reference material. It appears that the N content of the material is important for the weldability. A higher N-content results in a larger welding range.

The welding range for both the C-grain and the H-grain bodies of steel N exceeds the 300 Amp, which is a commonly used minimum standard for the size of a welding range for a production line. Steel Nb is not satisfactory for C nor for H-grain bodies, and the LC steel only performs well for C-grain bodies.

Cans, welded at ⅔ of the welding range, were subjected to the cone test. The can bodies (n=15) were tested at both ends of the bodies. The cone test involves pressing a cone with a top angle α of 40° into the body at a speed of 65 mm/min using an Instron 5567 compression/tension machine with a 30 kN loadcell. After mating the body with the cone the Force-Displacement curve is measured and the test is stopped once the body ruptures which is characterised by an abrupt drop in force. From the displacement of the cone the diameter at just before rupture can be determined. Rupture may occur in the material itself, in the weld, or in the HAZ. The displacement I of the cone until rupture is determined from the Force-Displacement curve, so the increase in diameter is 2·dR=2 tan (α/2) I. The absolute flanging capacity (in %) is therefore 2dR*100/D (%).

The tests showed no difference in flanging capacity between the two ends and these were therefore averaged. The results of the cone test are presented in table 5

TABLE 5
Absolute and relative flanging capacity (in %).

| | C - grain | H - grain | C - grain | H - grain |
|---|---|---|---|---|
| Nb | 9.15 | 7.67 | 35 | 13 |
| LC | 11.59 | 8.04 | 70 | 18 |
| N | 10.55 | 9.01 | 55 | 33 |

These results show that the flanging capacity of the C-grain bodies is higher than those for the H-grain bodies and the H-grain flanging capacity of the inventive material is larger than that of the reference materials. The inventors have determined that the absolute flanging capacity to obtain a flange width of 2.5 mm in a 73 mm diameter can body should be at least 6.8%. It can therefore be concluded that the N steel provides a considerable reserve potential in this respect because its flanging capacity is significantly higher than the required lower limit for both C- and H-grain (see table 5 (last two columns: flanging capacity-6.8)/6.8*100).

### BRIEF DESCRIPTION OF THE DRAWINGS

The invention will now be explained by means of the following, non-limiting figures.

FIG. 1 shows a schematic representation of the cold-rolling process according to the invention. In case the second cold rolling reduction (DR) is 0, then the bottom figure morphs into the top figure. Coating comprises tinning and optionally additional coatings such as a polymer coating.

FIG. 2 shows the principal difference between a C-grain and an H-grain can body.

FIG. 3 shows a strip produced according to the invention onto which the blanks for the three-piece can bodies are projected that, after cutting, enables production of H-grain can bodies on the top of the figure and a for a C-grain can body on the bottom.

FIG. 4 shows a cross-section of the weld in the three-piece can body, the heat affected zone and the side stripe consisting of a powder coating or a lacquer or the like to protect the coating free steel and the weld.

FIG. 5 shows a schematic drawing of a film lamination process that is used to cover the tinned steel substrate with a polymer film. The drawing shows a double-sided coating, but this can also be executed one-sided.

FIG. 6 shows a schematic drawing of a direct extrusion process that is used to cover the tinned steel substrate with a polymer film. The drawing shows a double-sided coating, but this can also be executed one-sided.

FIG. 7 shows a top view of a part of a polymer coated tinned steel substrate which shows strips that shows bare edges and a polymer coating free zone. The drawn lines in the coating free zones reflect the vertical cutting lines and the horizontal drawn lines reflect the horizontal cutting lines, wherein the distance between the horizontal lines is the blank height of the resulting three-piece can.

FIG. 8 shows the result of a good weld, a cold weld where the metal was not melted, and a hot weld where splatter occurred.

FIG. 9 shows the definition of the crown C40.

FIG. 10 shows the geometry of the cone test.

FIG. 11 shows a schematic cross sections (not to scale) of a laminate comprising a steel substrate, provided on both sides with a tin layer (steel substrate+tin layer=tinplate) and provided on both sides with a thermoplastic polymer laminate layer.

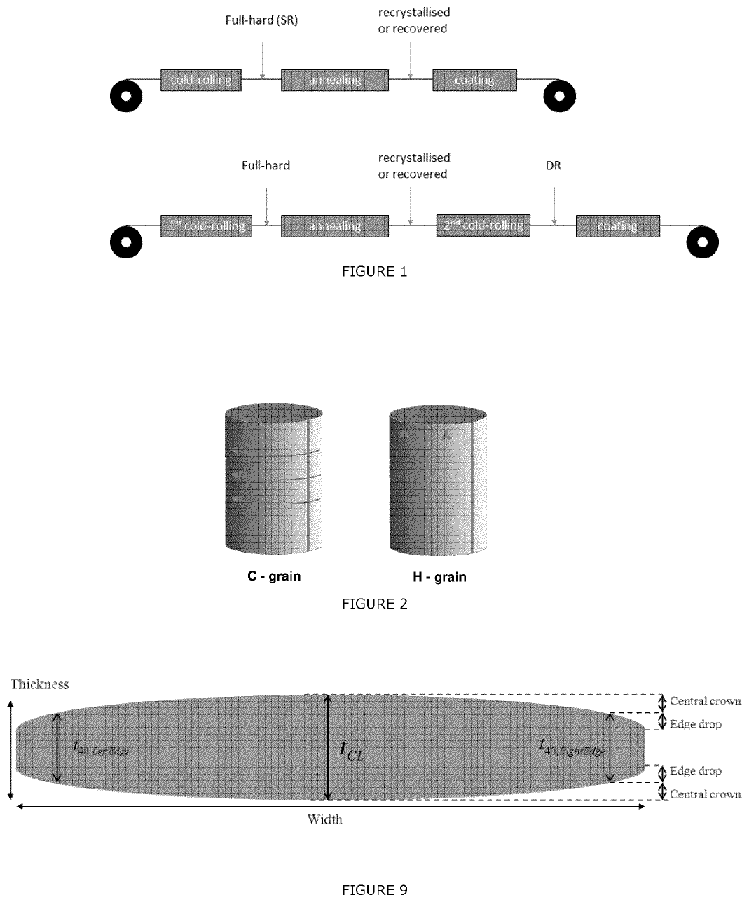

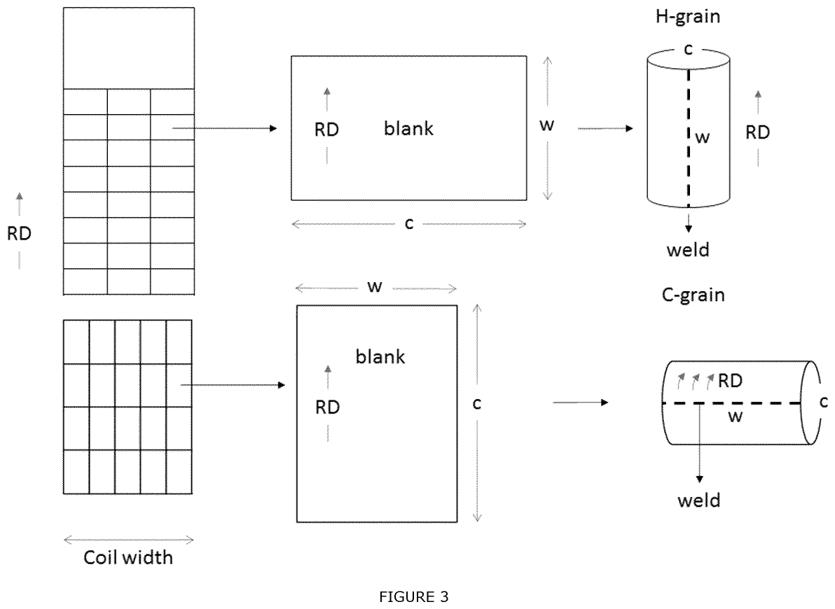

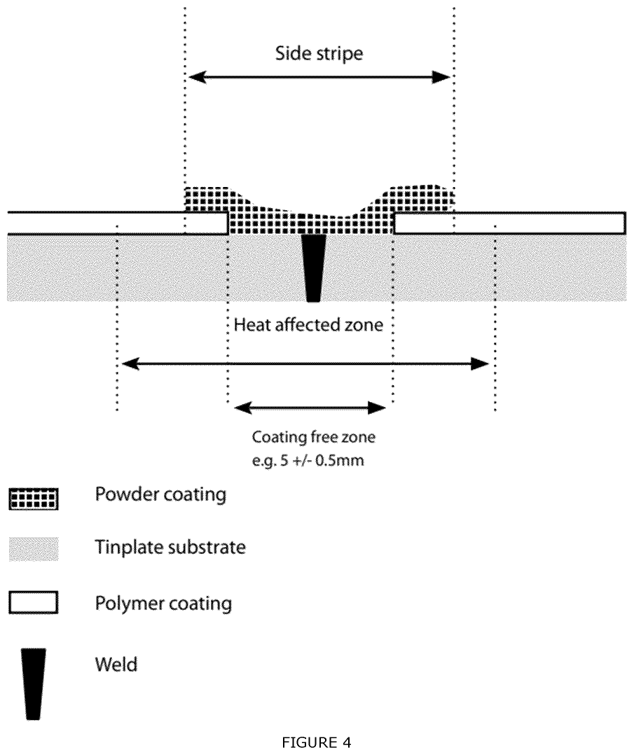

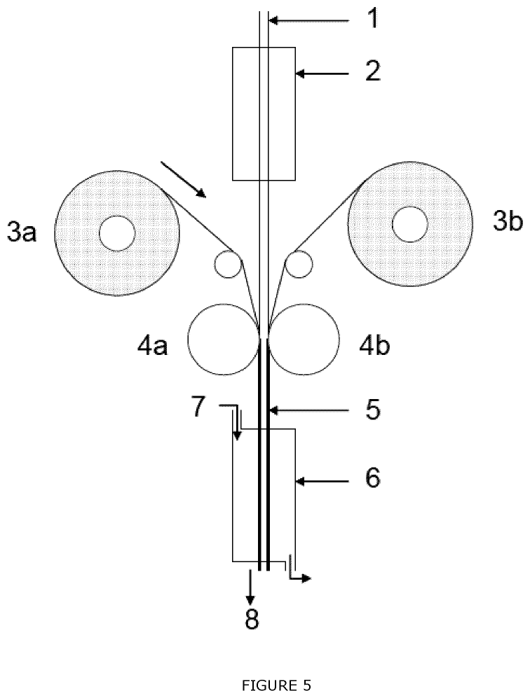

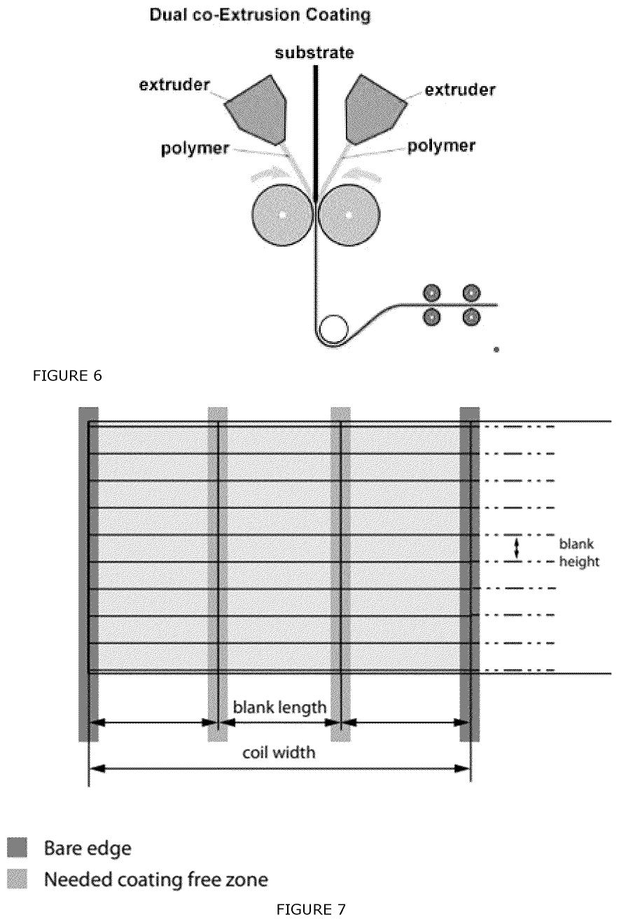

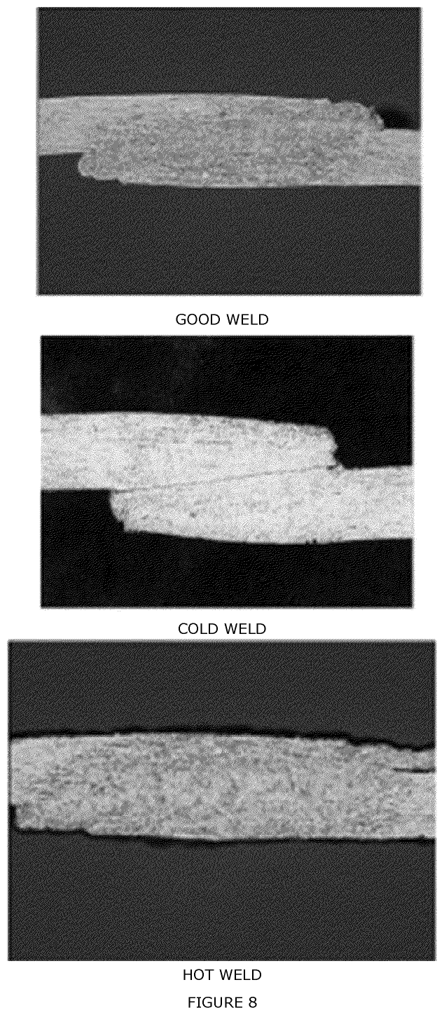

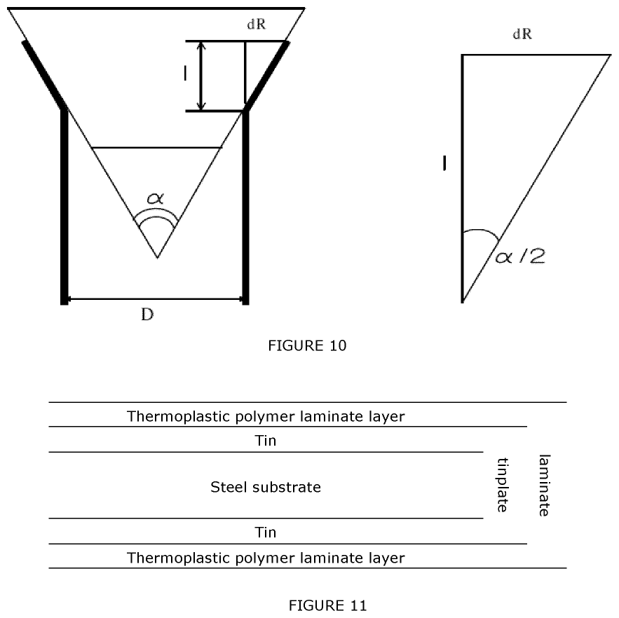

1. A method for producing high-strength tinplate with a lower yield strength (R_{eL}) of between 435 MPa and 700 MPa, as measured according to EN10002-1-2001 E, with improved H-grain weldability for three-piece can bodies, wherein the H-grain welding range is at least 300 A, comprising the subsequent steps of:
Producing a hot-rolled strip by hot-rolling a steel slab produced by a BOF-steelmaking process comprising (in wt. %):
C: 0.045-0.095;
Mn: 0.250-0.475;
Si: 0-0.030
Al_sol: 0.005-0.025;
N: 0.0070-0.0140;
S: 0-0.020;
P: 0-0.020;
Optionally one or more of the following:
Cr: 0-0.100;
Cu: 0-0.100;
Ni: 0-0.100;
Ti: 0-0.010;
Nb: 0-0.010;
V: 0-0.010;
remainder iron and inevitable impurities resulting from the steelmaking process;
followed by a first cold-rolling of the hot-rolled strip to an intermediate thickness, wherein the first cold-rolling reduction is between 85% and 91%, and wherein the cold-rolled strip is subsequently subjected to recrystallisation annealing by continuous annealing or batch annealing to produce a fully recrystallised annealed strip;
followed by a second cold rolling of the fully recrystallised annealed strip to a final thickness wherein the second cold-rolling reduction is between 2% and 17%;
followed by electro-tinning the annealed strip on one or both sides to produce tinplate.

2. The method according to claim 1, wherein the steel slab comprises:
Cr: 0-0.030;
Cu: 0-0.040;
Ni: 0-0.060;
Ti: 0-0.004;
Nb: 0-0.004;
V: 0-0.004;
Ni+Cu+Cr+Mo+Sn+Nb+Ti+V: 0-0.100.

3. The method according to claim 1, wherein the hot-rolled strip has a crown value C40 of at most 0.045 mm.

4. The method according to claim 1, wherein the steel slab comprises:
Si: 0-0.020 and/or
Ti: 0-0.002 and/or
Nb: 0-0.002.

5. The method according to claim 1, wherein the amount of tin on the tinplate is at most 5.0 g/m2.

6. The method according to claim 1, wherein the amount of tin on the tinplate is at least 1.5 g/m2.

7. The method according to claim 1, wherein a thermoplastic polymer laminate layer is applied to one or both sides of the tinplate to form a laminate.

8. The method according to claim 7, wherein the thermoplastic polymer laminate layer is applied to one or both sides of the tinplate by means of direct extrusion and in-line lamination, or by film lamination using an adhesion layer to bond the thermoplastic polymer laminate layer or layers to the tinplate, or by film lamination using heat-bonding to bond the thermoplastic polymer laminate layer or layers to the tinplate.

9. The method according to claim 18, wherein the laminate is slit into narrow laminate strips with a width c having unlaminated edges on either side in the direction parallel to the rolling direction by slitting the laminate along the unlaminated narrow longitudinal strips.

10. The method according to claim 1, wherein three-piece can bodies are producible from the tinplate or laminate by cutting rectangular body blanks therefrom, wherein the side c of the rectangular body blank which will form the circumference of the can body is perpendicular to the rolling direction of the cold-rolled strip, and wherein the side w where the weld to close the can body is to be made is parallel to the rolling direction of the tinplate or laminate (H-grain).

11. The method according to claim 1, wherein three-piece can bodies are producible from the tinplate or laminate by cutting rectangular body blanks therefrom, wherein the side c of the rectangular body blank which will form the circumference of the can body is parallel to the rolling direction of the cold-rolled strip, and wherein the side w where the weld to close the can body is to be made is perpendicular to the rolling direction of the tinplate or laminate (C-grain).

12. A high-strength tinplate with a lower yield strength (R_{eL}) of between 435 MPa and 700 MPa with improved H-grain weldability for three-piece can bodies comprising (in wt. %):
C: 0.045-0.095;
Mn: 0.250-0.475;
Si: 0-0.030
Al_sol: 0.005-0.025;
N: 0.0070-0.0140;
S: 0-0.020;
P: 0-0.020;
Optionally one or more of the following:
Cr: 0-0.100;
Cu: 0-0.100;
Ni: 0-0.100;
Ti: 0-0.010;
Nb: 0-0.010;
V: 0-0.010;
remainder iron and inevitable impurities,
produced according to claim 1.

13. The high-strength tinplate according to claim 12, comprising:
Cr: 0-0.030;
Cu: 0-0.040;
Ni: 0-0.060;
Ti: 0-0.004;
Nb: 0-0.004;
V: 0-0.004;
Ni+Cu+Cr+Mo+Sn+Nb+Ti+V: 0-0.100;

14. The high-strength tinplate according to claim 12, with a H-grain welding range of at least 350 A.

15. The high-strength tinplate or laminate according to claim 12 with a H-grain flanging capacity of at least 8.0%.

16. Body blanks for three-piece can bodies produced from the tinplate or laminate according to claim 12.

17. The three piece can bodies produced from the rectangular body blanks according to claim 16, wherein the body blank is shaped into a cylinder or any other suitable shape and welded to form open ended closed bodies wherein the weld seam that closes the can body is parallel to the rolling direction of the laminated tinplate.

18. The method according to claim 8, wherein a plurality of thermoplastic polymer laminate layers are applied to one or both sides of the tinplate in such a way that narrow longitudinal strips of tinplate remain unlaminated.

19. The method according to claim 7, wherein three-piece can bodies are producible from the laminate by cutting rectangular body blanks therefrom, wherein the side c of the rectangular body blank which will form the circumference of the can body is perpendicular to the rolling direction of the cold-rolled strip, and wherein the side w where the weld to close the can body is to be made is parallel to the rolling direction of the laminate (H-grain).

20. The method according to claim 7, wherein three-piece can bodies are producible from the laminate by cutting rectangular body blanks therefrom, wherein the side c of the rectangular body blank which will form the circumference of the can body is parallel to the rolling direction of the cold-rolled strip, and wherein the side w where the weld to close the can body is to be made is perpendicular to the rolling direction of the laminate (C-grain).
